(19) United States
(12) Patent Application Publication
(10) Pub. No.: US 2007/0075449 A1
(43) Pub. Date: Apr. 5, 2007

(54) Manufacturing method for optical film and manufacturing apparatus of optical film

(75) Inventor: Katsusuke Nagashima, Kobe-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: KONICA MINOLTA OPTO, INC.

(21) Appl. No.: 11/526,639

(22) Filed: Sep. 26, 2006

(30) Foreign Application Priority Data
Sep. 30, 2005 (JP) JP2005-288825

(51) Int. Cl. B29D 11/00

(52) U.S. Cl. 264/1.6; 264/216

(57) ABSTRACT

In a method of manufacturing an optical film by a casting apparatus which comprises a support, a casting die provided at a casting section of the support and a pressure reducing device provided at the casting section, a temperature T of the support at the casting section is set to satisfy the formula (1):
−0.01CS+0.005ΔP+5≦T≦−0.125CS+0.04ΔP+17 (1) where CS represents the moving speed (m/min) of the support and ΔP is a reduced pressure (Pa) at the back side of the dope ribbon by the reducing device.

This application is based on Japanese Patent Application No. 2005-288825 filed on Sep. 30, 2005, in Japanese Patent Office, the entire content of which is hereby incorporated by reference.

### BACKGROUND OF THE INVENTION

The presented invention relates to a manufacturing method for optical films used in various displays such as a liquid crystal display (LCD) and an organic electro-luminescence (EL) display, particularly relates to polarizing plate protective films used for these displays, and optical films having birefringence usable as phase difference films and a manufacturing apparatus of optical films.

Generally, a basic constitution of a liquid crystal display is that polarizing plates are installed on both sides of a liquid crystal cell. The polarizing plate passes only light of a plane of polarization in a fixed direction, so that in the liquid crystal display, it plays an important role for visualizing changes in the orientation of the liquid crystal due to the electric field and the performance of the liquid crystal display greatly depends on the performance of the polarizing plate.

In recent years, there is an increasing demand for the display quality of a thin liquid crystal display, and various liquid crystal display methods such as IPS, VA, and OCB are proposed, and the necessity for phase difference films is increased.

In recent years, with rapid spread of large liquid crystal televisions, demands for protective films and phase difference films are expanded rapidly, and to respond to it, conventionally, in manufacture of optical films by the solvent casting film forming method, when increasing the film forming speed by high concentration of a raw material solvent (hereinafter, called a dope), the film becomes streaky in the casting transfer direction, and quality deterioration such as deterioration of the flatness comes into a problem.

Further, in correspondence with speedup of manufacture of optical films by this solvent casting film forming method, rolling-in of bubbles occurs in the dope casting section and an occurrence of uneven film thickness due to non-uniformity of the film thickness comes into a problem.

Here, for improvement of the productivity of optical films, it is necessary to increase the film forming speed, though when the film forming speed is increased, in the liquid film portion (hereinafter, referred to as the dope ribbon) formed between the liquid outlet of the casting die and the support body, stronger shearing/extension stress is generated and the dope ribbon is extended longer and is put into an unstable state. Further, due to an increase in the film forming speed, the flow of air accompanied by the support body becomes stronger, and the accompanying air collides with the dope ribbon, thus the dope ribbon is made unstable.

In the unstable dope ribbon portion of the dope casting section, air is rolled in due to defective adhesion between the liquid film and the support body, and a failure of bubbles is caused to the formed film, and a problem arises that the acceptable product rate lowers. Particularly, the unstable dope ribbon end vibrates greatly, thus the formed film end is deformed in the undulated shape. This deformation causes folding of the web end at time of web transfer after separated from the support body and is led to breaking of the transfer films, that is, stop of the film forming line, thus a problem arises that the operation rate is lowered greatly.

And, conventionally, to suppress rolling-in of bubbles and disorder of the dope ribbon end when the film forming speed is increased, behind the casting die in the support body moving direction, a pressure reducing chamber is installed, and the upstream side part of the dope ribbon discharged from the casting die is made negative in pressure, and suppression of the aforementioned occurrence of a bubble failure of optical films is executed. However, when the pressure reduction degree by the pressure reducing means is increased to ensure the stability of the dope ribbon, the flow of air blowing into the pressure reducing chamber from the dope ribbon end becomes stronger, thus the dope ribbon end is dried early, and a solid film may be formed or inversely, the vibration of the dope ribbon end may be increased. And, an occurrence of a solid film at the dope ribbon end causes disorder of the formed film ends and taking advantage of the disorder of the dope ribbon end, a problem arises that films may be broken during transfer and the film forming line may be stopped.

Further, when condensing and using the solvent to decrease drying of the film end due to increasing of the film forming speed and the load of solvent collection, the dope liquid viscosity is increased and a problem arises that the aforementioned unstable phenomenon of the dope ribbon becomes more conspicuous.

Furthermore, in correspondence to increasing of the film forming speed, a problem arises that film thickness irregularities due to non-uniformity of the film thickness in the width direction and longitudinal direction of films, particularly transverse irregularities of several millimeters of pitches generated in the width direction of films, and streak-like film thickness irregularities in the longitudinal direction of films occur easily.

Here, conventionally, there are the following patent documents regarding the manufacturing method for cellulose ester films available.

Japanese Patent Application 11-216732 discloses a manufacturing method for cellulose triacetate films for specifying, when preparing cellulose triacetate films by the solvent casting film forming method, to cast a dope onto the support body of the casting section from the die, the temperature of the support body at the casting position.

Japanese Patent Application 2000-301588 discloses a solvent casting film forming method, in manufacture of resin films by the solvent casting film forming method of a resin solvent using a pressure reducing chamber, for specifying the discharging speed of the resin solvent from the front end of the casting die and the pressure reduction degree of the pressure reducing chamber, thereby reducing uneven thickness of resin films in the longitudinal direction.

Japanese Patent Application 2002-144357 discloses a solvent film forming method of cellulose acetate using a casting band for installing a backsuction device behind the casting die and specifying the interval between the backsuction device and the casting band and describes that the method increases the manufacturing speed of cellulose acetate films.

However, in the conventional manufacturing method for cellulose triacetate films described in Japanese Patent Application 11-216732, the support body temperature at time of dope casting is specified. However, mainly in response to uneven film thickness, only the relationship between the support body temperature and the boiling point of the solvent is referred to and as a countermeasure for rolling-in of bubbles at time of dope casting which is questionable at present, the art described in Japanese Patent Application 11-216732 is insufficient and a countermeasure including the pressure reduction degree of the-casting section and film forming speed is necessary.

On the other hand, in the conventional solvent casting film forming methods described in Japanese Patent Application 2000-301588 and Japanese Patent Application 2002-144357, the arts described are for the constitution of the pressure reducing chamber and a problem arises that they are insufficient for film forming at high speed and high concentration.

### SUMMARY OF THE INVENTION

An object of the present invention is to solve the above problems of the prior arts and provide a manufacturing method for optical films and a manufacturing apparatus of optical films for, when increasing the film forming speed in the solvent casting film forming method, avoiding excessive pressure reduction for making a dope ribbon formed between the liquid outlet of the casting die and the support body unstable, eliminating rolling-in of bubbles at the casting section even in film forming at high speed, forming a stable casting dope ribbon at time of dope casting, thereby obtaining films of good quality free of uneven film thickness.

The inventor pursued earnest studies to solve the aforementioned problems of the prior arts, found a method for, in the solvent casting film forming method, setting the support body temperature at time of casting within a specific range of a fixed value or lower, devising the shape and dimensions of the pressure reducing chamber, thereby suppressing rolling-in of bubbles at the dope casting section and an occurrence of uneven film thickness due to non-uniform film thickness even at time of film forming at high speed, and obtaining optical films of good surface quality, thereby completed the present invention.

The above object can be attained by the present invention described in anyone of the following items.
Item 1. A method of manufacturing an optical film by a casting apparatus which comprises a support, a casting die provided at a casting section of the support and a pressure reducing device provided at the casting section, the method comprises steps of:
   moving the support at a moving speed of 50 to 225 m/min in a moving direction;
   casting a dope solution containing a solvent and a thermoplastic resin dissolved in the solvent from a solution outlet of the casting die to a surface of the support so that the dope solution forms a dope ribbon between the solution outlet of the casting die and the surface of the support;
   reducing a pressure at a back side of the dope ribbon in the moving direction of the support by the pressure reducing device; and
   setting a temperature T of the support at the casting section to satisfy the formula (1):
      −0.01CS+0.005ΔP+5≦T≦−0.125CS+0.04ΔP+17 (1)
      where CS represents the moving speed (m/min) of the support and ΔP is a reduced pressure (Pa) at the back side of the dope ribbon by the reducing device.
Item 2. In the method of Item 1, the setting-step sets the temperature T of the support at the casting section to satisfy the formula (2):
   −0.01CS+0.005ΔP+9≦T≦−0.125CS+0.04ΔP+12 (2)
Item 3. In the method of Item 1, the following formula (3) is satisfied:
   10≦−0.01CS+0.005ΔP (3)
Item 4. In the method of Item 1, the setting step sets the temperature T of the support at the casting section to satisfy the formula (4):
   15≦T≦−0.125CS+0.04ΔP+17 (4)
Item 5. In the method of Item 1, the following formula (5) is satisfied:
   3CS≦ΔP≦4CS+600 (5)
Item 6. In the method of Item 1, wherein the moving speed of the support is 100 to 200 m/min.
Item 7. In the method of Item 1, wherein a temperature of the dope solution is 5° C. or more lower than a boiling point. of the solvent and an atmospheric temperature around the casting section is 15 to 30° C.
Item 8. In the method of Item 1, the pressure reducing device comprises a pressure reducing chamber at the back side of the casting die and at least one partition plate provided in the pressure reducing chamber and a distance (L) between the solution outlet of the casting die and a partition plate located closest to the casting die is 50 to 150 mm.
Item 9. In the method of Item 1, a gap between the partition plate and the support is 2 to 20 mm.

According to the present invention described in Items 1 to 6, in the manufacture of optical films by the solvent casting film forming method, the temperature of the support body immediately before casting of the dope is set within a specific range decided by the moving speed of the support body and the pressure reduction degree of the dope casting section, thus bubbles can be prevented from rolling in free of excessive pressure reduction for making the dope ribbon formed between the liquid outlet of the casting die and the support body unstable, and for example, even at time of film forming at high speed, a stable casting dope ribbon can be formed at time of dope casting, and optical films of good quality free of irregularities overall the film width and good in flatness can be obtained, and when it is applied to an image display, optical films realizing a visible display having a high contrast ratio in a wide range can be obtained, and moreover, even at a high temperature and high humidity, optical films for ensuring a stable phase difference value can be obtained.

According to the invention described in Item 7, the dope temperature at time of casting is lowered, and the atmospheric temperature at time of casting is kept appropriately, thus an occurrence of transverse irregularities of the formed films can be prevented.

According to the invention described in Item 8, the partition plate is installed in the pressure reducing chamber, and the distance between the partition plate and the casting dope ribbon is kept appropriately, thus even at time of film forming at high speed, a stable casting dope ribbon can be formed at time of dope casting, and bubbles can be prevented from rolling in, and optical films of good quality free of irregularities overall the film width and good in flatness can be obtained.

### BRIEF DESCRIPTION OF THE DRAWINGS

FIG. 1 is a flow sheet of the solvent casting film forming apparatus for executing the manufacturing method for optical films of the present invention.

FIG. 2 is an enlarged cross sectional view of the essential section of the casting die and pressure reducing chamber shown in FIG. 1.

FIG. 3 is an enlarged cross sectional view of the essential section showing a modification of the pressure reducing chamber.

FIG. 4 is an enlarged cross sectional view of the essential section showing another modification of the pressure reducing chamber.

### DETAILED DESCRIPTION OF THE PREFERRED EMBODIMENT

Hereinafter, the present invention will be explained in detail.

As an optical film manufactured by the method of the present invention, the followings are listed up as desirable requirements that a production is easy, an adhesion property with an activity ray hardening type resin layer is excellent, and it is optically transparent.

Here, with regard to an optical film, transparency, as described in the present invention, refers to visible light transmittance of 60 percent or more, preferably 80 percent or more, and most preferably 90 percent or more.

The film is not particularly limited as long as it exhibits the aforesaid properties. AS a resin preferably used in the present invention, a homopolymer or copolymer which has an ethylenic unsaturated monomer unit can be mentioned. More preferably, a homopolymer or copolymer of acrylic acid or methacrylate ester, such as a copolymer of polyacrylic acid methyl, polyacrylic acid ethyl, polyacrylic acid propyl, polyacrylic acid cyclohexyl, and acrylic acid alkyl, polymethyl methacrylate, polymethacrylic acid ethyl, polymethacrylic acid cyclohexyl, and methacrylic acid alkyl ester copolymer, are listed ups. Still more, since an ester of acrylic acid or methacrylic acid is excellent in transparency and compatibility, a homopolymer or a copolymer which has an acrylic ester or a methacrylate ester unit, especially a homopolymer or a copolymer which has an acrylic acid or a methyl methacrylate unit is desirable. Concretely, a polymethyl methacrylate is desirable. Acrylic acid such as polyacrylic acid and polymethacrylic acid cyclohexane, or an alicyclic alkyl ester of a methacrylic acid has advantages such as high heat-resisting property, low moisture-absorption characteristics and low birefringence, therefore these are desirable.

As the other resin preferably used in the present invention, for example, a cellulose ester resin having an acyl group substitution degree of 1.8 to 2.80, such as a cellulose acetate, a cellulose acetate propionate, a cellulose acetate butyrate, moreover, a cellulose ether resin having an alkyl group substitution degree of 2.0 to 2.80, such as cellulose methyl ether, cellulose ethyl ether, and cellulose propyl ether, cycloolefin resin, norbornane type resin, polycarbonate resin, moreover, polyamide resin of a polymer of alkylene dicarboxylic acid and diamine, moreover, a polyester resin, such as a polymer of alkylene dicarboxylic acid and diol, a polymer of alkylene diol and dicarboxylic acid, a polymer of cyclohexane dicarboxylic acid and diol, a polymer of cyclohexane diol and dicarboxylic acid, a polymer of aromatic dicarboxylic acid and diol, and a polyvinyl acetate, vinyl acetate resin such as a vinyl acetate copolymer, and polyvinyl acetal, a polyvinyl acetal resin such as a polyvinyl butyral, an epoxy resin, a ketone resin, and a polyurethane resin such as a line polymer of alkylene diisocyanate and alkylene diol, etc. can be listed, and it is desirable to contain at least one chosen from these.

Especially, a cellulose ester type resin, such as a cellulose acetate, cellulose acetate propionate, and a cellulose acetate butyrate, a cycloolefin resin,a norbornane type resin, and a polycarbonate resin are desirable. Moreover, although dope dissolving may be conducted after two or more kinds of polymers with compatibility are blended, the present invention is not limited to these.

The production method of an optical film of the present invention is conducted by a solution casting film forming method, and this is explained in detail.

(Materials to form a Dope Solution)

Hereafter, the present invention is explained by taking a cellulose ester as an example.

A cellulose ester solution containing a cellulose ester and an organic solvent is called a dope solution, a solution casting film production is carried out with this, and thereby forming a cellulose ester film in the present invention.

(Cellulose Ester)

Cellulose as a source material of the cellulose ester of the present invention is not specifically limited, however, usable are cotton linter, wood pulp (obtained from acicular trees or from broad leaf trees) or kenaf. The cellulose esters obtained from these cellulose source materials may also be used independently or by mixing with each other in any ratio.

In the present invention, in the case that an acylation agent of a source material of cellulose is an acid anhydride (acetic anhydride, propionic anhydride, and butyric anhydride), cellulose ester can be prepared through a reaction using an organic acid such as acetic acid and an organic solvent such as methylene chloride, in the presence of a protic catalyst such as sulfuric acid. When an acylation agent is an acid chloride (CH₃COCl, C₂H₅COCl or C₃H₇COCl), a reaction is carried out using a basic compound such as an amine as a catalyst. Specifically, the reaction can be carried out according to the method disclosed in JP-A No. 10-45804.

In an acylation reaction to form a cellulose ester, an acyl group reacts with the hydroxyl group of a cellulose molecule. A cellulose molecule is made up of many glucose units connected each other, and a glucose unit contains three hydroxyl groups. The number of hydroxyl groups substituted by acyl groups in a glucose unit is referred to as a degree of acetyl substitution. For example, in the case of cellulose triacetate, all the three hydroxyl groups in one glucose unit are substituted by-acetyl groups.

In a cellulose ester used for a cellulose ester film, the total degree of acetyl substitution is preferably 2.4 to 2.8.

The molecular weight of cellulose ester used in the present invention is preferably 50,000 to 200,000 in number average molecular weight (Mn), more preferably 60,000 to 200,000, and still more preferably 80,000 to 200,000.

In the cellulose ester used by this invention, the ratio Mw/Mn of a weight average molecular weight to a number average molecular weight is preferably 1.4 to 3.0, and more preferably 1.7 to 2.2.

The mean molecular weight and molecular weight distribution of cellulose ester can be measured by a fast liquid chromatography. The ratio of mass mean molecular weight (Mw) to number average molecular weight (Mn) can be calculated from the results of measurement.

The measuring condition is as follows:

Solvent: Methylene chloride

Column: Shodex K806, K805, K803G (manufactured by Showa Denko KK) . Three columns were used in connection.

Column temperature: 25° C.

Sample concentration: 0.1 mass %

Detector: RI Model 504 (manufactured by GL Science)

Pump: L6000 (manufactured by Hitachi Ltd.)

Flow rate: 1.0 ml/min

Calibration curve: Standard polystyrene STK (manufactured by Tosoh Corporation) . Calibration curve using 13 samples of Mw=1,000,000 to 500. 13 samples should preferably be spaced approximately equally.

A cellulose ester of the present invention is a carboxylic acid ester having from 2 to around 22 carbon atoms. Specifically, a lower fatty acid ester of cellulose is preferable.

A lower fatty acid in the lower fatty acid ester of cellulose represents a fatty acid having 6 carbon atoms or less. Examples of a specific lower fatty acid ester of cellulose include: cellulose acetate, cellulose propionate, cellulose butyrate, cellulose acetate phthalate and mixed fatty acid esters, for example, cellulose acetate propionate and cellulose acetate butylate, which are disclosed in JP-A No. 10-45804, No. 8-231761 and U.S. Pat. No. 2,319,052. Or, an ester of an aromatic carboxylic acid and a cellulose and a cellulose acylrate described in JP-A No. 2002-179701, JP-A No. 2002-265639 and JP-A No. 2002-265638 are used preferably.

Of these, cellulose triacetate and cellulose acetate propionate are specifically preferable as the lower fatty acid ester of cellulose of the present invention. These cellulose esters may also be used in combination.

A preferable cellulose ester other than cellulose triacetate contains an acyl group having 2-4 carbon atoms as a substituent and satisfies the following Formulas (a) and (b), provided that X represents a substitution degree of an acetyl group and Y represents a substitution degree of a propionyl group or a butyryl group.
2.4≦X+Y≦2.8 Equation (a)
0≦X≦2.5 Equation (b)

Portions which are not substituted by acyl groups usually exist as hydroxy groups. These can be synthesized by well-known methods.

The acylation degree of a cellulose ester is determined according to the method specified in ASTM-D 817-96.

In the case of the acetyl cellulose, the time for acetylation should be prolonged for rising the acetylation degree. However, excessively long time for the acetylation causes simultaneously progress of decomposition and brings undesirable results caused by scission of the polymer chain and the decomposition of acetyl group. It is necessary, therefore, to set the reaction time within a certain range for raising the acetylation degree and inhibiting the decomposition within desired degree. It is unsuitable to control the reaction only by the reaction time because various conditions are applied and the reaction is largely varied depending on the conditions such as the reaction apparatus and equipment. The molecular weight distribution is expanded accompanied with the progression of decomposition of the polymer. Accordingly, the degree of the decomposition can be decided by the usually used value of the ratio of weight average molecular weight Mw to number average molecular weight Mn also in the case of the cellulose ester. Namely, the ratio of Mw/Mn can be used as an indicator of the reaction degree for carrying out acetylation reaction for sufficient time without causing excessively decomposition by the reaction for too long time.

An example of the production method for the cellulose ester is described below. One hundred parts by weight of cotton linter as the raw cellulose material was crushed and 40 parts by weight of acetic acid was added and subjected to a pre-activation treatment at 36° C. for 20 minutes. After that, 8 parts by weight of sulfuric acid, 260 parts by weight of acetic anhydride and 350 parts by weight of acetic acid were added to the above cotton linter and then acetylation was carried out at 36° C. for 120 minutes. The reaction system was neutralized by 11 parts by weight of 24% aqueous solution of magnesium acetate and saponified and ripened at 63° C. for 35 minutes to obtain acetyl cellulose. The acetyl cellulose was stirred at room temperature for 160 minutes using 10 times of an aqueous solution of acetic acid (acetic acid : water=1:1 in weight ratio) and then filtered and dried. Thus purified acetyl cellulose having an acetylation ratio of 2.75 was obtained. The acetyl cellulose had a Mn of 92,000, Mw of 156,000 and Mw/Mn of 1.7. Acetyl celluloses each having various acetylation degrees and Mw/Mn ratios can be synthesized by varying the acetylation conditions such as temperature, time and stirring and that of the hydrolysis.

The synthesized cellulose ester is preferably subjected to purification for removing low molecular weight component and to filtration for removing un-acetylated and low-acetylated components.

The mixed acid cellulose ester can be obtained by the method described in Tokkai Hei 10-45804. The acylation degree can be measured according to the method prescribed in ASTM-D817-9.

The cellulose ester is influenced by very small quality of metal component contained therein. It is supposed that the presence of the metal component is related to the water used in the production process of the cellulose ester. The component capable of forming an insoluble nucleus is preferably small in the amount. The amount of a metal ion such as iron, calcium and magnesium is preferably small because such the ion sometimes forms an insoluble substance by foaming a slat with a polymer decomposition product having a possibility of containing an organic acid group. The content of the iron (Fe) component is preferably not more than 1 ppm. The component of calcium (Ca) is much contained in ground water and river water, and water having a high content of the calcium ion becomes hard water, which is unsuitable for drinking water. The calcium component tends to form a coordination compound or a complex with an acidic component such as carboxylic acid or sulfonic acid or many kinds of ligand and causes scum (precipitation and turbid of insoluble compound) derived from the insoluble calcium compound.

The amount of the calcium (ca) component is not more than 60 ppm, and preferably from 0 to 30 ppm. The amount of the magnesium (Mg) component is preferably from 0 to 70 ppm, and particularly preferably from 0 to 20 ppm, because the excessive presence of the magnesium component forms an insoluble substance. The amount of the metal components such as iron (Fe), calcium (Ca) and magnesium (Mg) can be measured by inductively coupled plasma-atomic emission spectrometry (ICP-AES) after a pretreatment in which an absolutely dried cellulose ester sample is subjected to decomposition by a micro-digesting wet decomposition apparatus (decomposition by sulfuric acid and nitric acid) and alkali fusion.

(Dope Solution)

Organic solvents used for a dope, in which cellulose ester is dissolved, include chlorine based organic solvents and non-chlorine organic solvents. Methylene chloride which is one of chlorine based organic solvents is suitable for dissolving cellulose ester, specifically cellulose acetate. A non-chlorine based organic solvent may also be used.

Examples of a non-chlorine based organic solvent include: methyl acetate, ethyl acetate, amyl acetate, acetone, tetrahydrofuran, 1,3-dioxolane, 1,4-dioxane, cyclohexanone, ethyl formate, 2,2,2-trifluoro ethanol, 2, 2,3,3-tetrafluoro-1-propanol, 1,3-difluoro-2-propanol, 1,1,1,3,3,3-hexafluoro-2-methyl-2-propanol, 1,1,1,3,3,3-hexafluoro-2-propanol, 2,2,3,3,3-pentafluoro-1-propanol and nitroethane.

When these organic solvents are used to dissolve cellulose acetate, an ambient temperature dissolving technique is useful, however, an elevated temperature dissolving technique, a cooled solvent dissolving technique, and a high pressure dissolving technique are also preferable since the insoluble portion is reduced. Methylene chloride is preferably used, however, methyl acetate and ethyl acetate and acetone are also preferably used. Of these, methyl acetate is specifically preferable. An organic solvent in which a cellulose ester is well dissolved is called “a good solvent”. An organic solvent which mainly contributes for dissolution and mainly contained in a solution is called “a main organic solvent”.

In a dope used in the present invention, 1 to 40% by weight of alcohol having a carbon number of 1 to 4 is preferably added in addition to the above described organic solvent. When alcohol is contained in a web, after casting a dope on a support and the solvent being partially evaporated from the web, the relative concentration of alcohol becomes higher and the web begins to gelate. The gelation increases the mechanical strength of the web and makes it easier to peel the web from the support. A smaller concentration of alcohol in a dope may contribute to increase a solubility of cellulose ester in a non-chlorine based organic solvent. Examples of an alcohol having a carbon number of 1 to 4 include: methanol, ethanol, n-propanol, iso-propanol, n-butanol, sec-butanol and tert-butanol. Among these alcohols, ethanol is specifically preferable, because ethanol is stable, having a low boiling point, being easy to evaporate and non-toxic. Since these organic solvent has not solubility independently for a cellulose ester, these are referred to as “a poor solvent”.

In order to maintain a high quality surface of a film, the concentration of cellulose ester is preferably 15 to 30% by weight, and the viscosity of a dope is preferably 10 to 500 Pa·s.

As additives added in a dope solution, there are fine particles, such as a plasticizer, a UV absorber, an antioxidant, a dye, and matting agent. In the present invention, these additives may be added in the case of manufacture of a cellulose ester solution, or may be added in the case of manufacture of a fine particle dispersion liquid of such as a matting agent.

It is desirable to add a plasticizer which gives heat resistance and moisture resistance, an antioxidant and a UV absorber, etc. to the polarizing plate used for a liquid crystal image display device.

Hereafter, Additives are explained.

(Plasticizer)

In the present invention, into a cellulose ester solution or a dope solution, it is desirable to add a compound known as a so-called plasticizer for the purposes of improving a mechanical property, providing a flexibility, providing a water absorbent-proof, reducing a water vapor permeation rate, and adjusting a retardation, for example, phosphate ester and carboxylate ester are preferably used for it.

As phosphate ester, for example, triphenyl phosphate, tricresyl phosphate, phenyl diphenyl phosphate, etc. can be listed up.

As carboxylate ester, phthalic ester and citrate ester, as phthalic ester, for example, dimethyl phthalate, diethyl phosphate, dioctyl phthalate, diethyl hexyl phthalate, etc., as citrate ester, citric acid acetyl triethyl and citric acid acetyl tributyl are listed up. Moreover, in addition to this, butyl oleate, methyl ricinoleate acetyl, sebacic acid dibutyl, triacetin, etc. are listed up. Alkyl phthalyl alkyl glycolate is also preferably used for this purpose. An alkyl of alkyl phthalyl alkyl glycolate is an alkyl group having carbon atom numbers of 1-8. As alkyl phthalyl alkyl glycolate, methyl phthalyl methyl glycolate, ethyl phthalyl ethyl glycolate, propyl phthalyl propyl glycolate, butyl phthalyl butyl glycolate, octyl phthalyl octyl glycolate, methyl phthalyl ethyl glycolate, ethyl phthalyl methyl glycolate, ethyl phthalyl propyl glycolate, propyl phthalyl ethyl glycolate, methyl phthalyl propyl glycolate, methyl phthalyl butyl glycolate, ethyl phthalyl butyl glycolate, butyl phthalyl methyl glycolate, butyl phthalyl ethyl glycolate, propyl phthalyl butyl glycolate, butyl phthalyl propyl glycolate, methyl phthalyl octyl glycolate, ethyl phthalyl octyl glycolate, octyl phthalyl methyl glycolate, Octyl phthalyl ethyl glycolate etc. can be mentioned, and preferably, methyl phthalyl methyl glycolate, ethyl phthalyl ethyl glycolate, propyl phthalyl propyl glycolate, butyl phthalyl butyl glycolate, and octyl phthalyl octyl glycolate can be used. Moreover, these alkyl phthalyl alkyl glycolate may be used as a mixture of two or more kinds.

Further, a polyalcohol is also preferably used.

A polyalcohol used in the present invention is represented by formula (1).
R₁—(OH)n Formula (1)
Wherein: R₁ represents an organic acid having a valence of n, n represents a positive integer of 2 or more and OH represents an alcoholic and/or a phenolic hydroxyl group.

A polyalcohol ester consists of an ester of an aliphatic polyalcohol having a valence of two or more and monocarboxylic acid, and preferably includes an aromatic ring or a cycloalkyl ring in a molecule. An aliphatic polyalcohol having a valence of 2 to 20 is preferable.

Examples of a preferable polyalcohol are listed below, however, the present invention is not limited thereto: adonitol, arabitol, ethylene glycol, diethylene glycol, triethylene glycol, tetraethylene glycol, 1,2-propanediol, 1,3-propanediol, dipropylene glycol,-tripropylene glycol, 1,2-butanediol, 1,3-butanediol, 1,4-butanediol, dibutylene glycol, 1,2,4-butanetriol, 1,5-pentanediol, 1,6-hexanediol, hexanetriol, galactitol, mannitol, 3-methylpentane-1,3,5-triol, pinacol, sorbitol, trimethylolpropane, trimethylolethane and xylitol.

A mono carboxylic acid to be used for the polyalcohol ester is not specifically limited, and well known compounds such as aliphatic monocarboxylic acid, alicyclic monocarboxylic acid and aromatic monocarboxylic acid may be used. Alicyclic monocarboxylic acid or aromatic. monocarboxylic acid is preferably used with respect to improving moisture permeability and retention of additives.

Examples of preferable monocarboxylic acids are listed below, however, the present invention is not limited thereto.

For aliphatic monocarboxylic acids, normal or branched fatty acids having from 1 to 32 carbon atoms are preferably used. The number of carbon atoms is more preferably from 1 to 20 and still more preferably from 1 to 10. The use of an acetic acid will help improve the mutual solubility, so that a mixture of an acetic acid and other monocarboxylic acids is also preferable.

Examples of preferable aliphatic mono carboxylic acids include saturated fatty acids such as: acetic acid, propionic acid, butyric acid, valeric acid, caproic acid, enanthic acid, caprylic acid, pelargonic acid, capric acid, 2-ethyl-hexanoic acid, undecylic acid, lauric acid, tridecylic acid, myristic acid, pentadecylic acid, palmitic acid, heptadecanoic acid, stearic acid, nonadecane acid, arachidic acid, behenic acid, lignoceric acid, cerotinic acid, heptacosanoic acid, montanic acid, melissic acid, lacceric acid, as well as unsaturated fatty acids such as: undecylic acid, oleic acid, sorbic acid, linoleic acid, linolenic acid and arachidonic acid.

Examples of preferable alicyclic monocarboxylic acids include: cyclopentanecarboxylic acid, cyclohexanecarboxylic acid, cyclooctanecarboxylic acid, and derivatives thereof.

Examples of preferable aromatic monocarboxylic acids include: benzoic acid and toluic acid, both of which have benzene ring in which alkyl groups are introduced, biphenylcarboxylic acid, naphthalenecarboxylic and tetralincarboxylic acid having 2 or more benzene rings, and derivatives thereof, of these, benzoic acid is specifically preferred.

The molecular weight of the polyalcohol ester is not limited, however, the molecular weight is preferably from 300 to 1,500 and more preferably from 350 to 750. A higher molecular weight is preferable in that the volatility of the polyalcohol is reduced, while a lower molecular weight is preferable with respect to moisture permeability, or to mutual solubility with cellulose ester.

To be used for a polyalcohol (polyvalent alcohol) ester, carboxylic acid may be used alone or in combination of two or more carboxylic acids. Hydroxyl groups in a polyalcohol may be completely esterified or only partially esterified remaining unsubstituted hydroxyl groups.

It is desirable that these compounds are contained 1 to 30% by weight to a cellulose ester, more preferably, contained 1 to 20% by weight. Further, in order to suppress bleed-out under stretching and drying processes, it is desirable that these compounds are compounds having a vapor pressure of 1400 Pa or less at 200 degrees C.

These compounds are may be added with cellulose ester and a solvent in the case of manufacture of a cellulose ester solution, or these compounds may be added during solution preparation or after preparation.

As other additives, polyester and polyester ether described in a Japanese Patent O.P.I. Publication No. 2002-22956, polyurethane resin described in a Japanese Patent O.P.I. Publication No. 2003-171499, rosin and a rosin derivative, and epoxy resin, a ketone resin, a toluenesulfonamide resin described in a Japanese Patent O.P.I. Publication No. 2002-146044, an ester of carboxylic acid and a polyvalent alcohol described in a Japanese Patent O.P.I. Publication No. 2003-96236, a composition represented by the general formula (1) described in a Japanese Patent O.P.I. Publication No. 2003-165868, a polyester polymer or a polyurethane polymer described in a Japanese Patent O.P.I. Publication No. 2004-292696 may be listed up. These additives may be contained in a dope solution or a fine particle dispersion liquid.

Ultraviolet (UV) Absorber

In the present invention, a ultraviolet absorber may be contained in a cellulose ester film.

Examples of a UV absorber used in the present invention include: oxybenzophenone-based compounds, benzotriazole-based compounds, salicylate-based compounds, benzophenone-based compounds, cyanoacrylate-based compounds, nickel complex-based compounds and benzotriazole-based compounds. Among these, benzophenone-based compounds and, which exhibit negligible coloring, are specifically preferable. UV absorbers disclosed in JP-A Nos. 10-182621, 8-33757A, and 2000-72782 and a polymer UV absorber disclosed in JP-A Nos. 6-148430, 2002-31715, 2002-169020, 2002-47357, 2002-363420, and-2003-113317 are also preferable. A UV absorber preferably has a superior absorbance in a wavelength range of 370 nm or less, in order to prevent deterioration of a polarizing element or a display under UV rays, and has a smaller absorbance in the visible light region at a wavelength range of 400nm or more, in order to provide a superior image quality of a liquid crystal display.

Specific examples of a preferable benzotriazole-based UV absorber include: 2-(2′-hydroxy-5′-methylphenyl) benzotriazole, 2-(2′-hydroxy-3′,5′-di-tert-butylphenyl) benzotriazole, 2-(2′-hydroxy-3′-tert-butyl-5′-methylphenyl) benzotriazole, 2-(2′-hydroxy-3′,5′-di-tert-butylphenyl)-5-chlorobenzotriazole, 2-(2′-hydroxy-3′-(3″,4″,5″,6″-tetrahydrophthalimidomethyl)-5′-methylphenyl) benzotriazole, 2,2-methylenebis(4-(1,1,3,3-tetramethylbutyl)-6-(2H-benzotriazole-2-yl)phenol), 2-(2′-hydroxy-3′-tert-butyl-5′-methylphenyl)-5-chlorobenzotriazole, 2-(2H-benzotriazole-2-yl)-6-(normal chain and side chain dodecyl)-4-methylphenol, and a mixture of octyl-3-[3-tert-butyl-4-hydroxy-5-(chloro-2H-benzotriazole-2-yl)phenyl]propionate and 2-ethylhexyl-3-[3-tert-butyl-4-hydroxy-5-(5-chloro-2H-benzotriazole-2-yl) phenyl]propionate. However, the present invention is not limited thereto. Commercially available Tinuvin 109, Tinuvin 171 and Tinuvin 326 (all produced by Ciba Specialty Chemicals Inc.) may also be preferably used. As a macromolecule UV. absorber, a reaction type UV absorber RUVA-93 by Otsuka chemistry company can be mentioned as an example.

Examples of benzophenone-based compounds include: 2,4-dihydroxybenzophenone, 2,2′-dihydroxy-4-methoxybenzophenone, 2-hydroxy-4-methoxy-5-sulfobenzophenone, and bis(2-methoxy-4-hydroxy-5-benzoylphenylmethane) . However, the present invention is not limited thereto.

As a UV absorber of the above-mentioned description preferably used by the present invention, since a benzotriazole type UV absorber or benzophenone type UV absorber has high transparency and is excellent in the effect to prevent deterioration of a polarizing plate and a liquid crystal element, these are desirable, and especially the benzotriazole type UV absorber which has less unnecessary coloring is used preferably.

The method of adding an ultraviolet absorber to the dope solution is not limited when the compounds are soluble in the solvent. However, in the present invention, a UV absorber is preferably preliminarily dissolved in, a solvent which is a good solvent for a cellulose ester, for example, methylene chloride, methyl acetate, and dioxolane or a mixed solvent of a good solvent and a poor solvent, for example, a lower aliphatic alcohol (methanol, ethanol, propanol or butanol), and then the ultraviolet absorber is added as a ultraviolet absorber solution in a cellulose ester solution. Or, an ultraviolet absorber may be added directly in a dope composition. As to a composition like inorganic powder not being dissolved in an organic solvent, it is added into a dope after it is dispersed into an organic solvent and a polymer by using a dissolver and a sandmill.

The content of a UV absorber is 0.5 to 3% by weight, especially 0.01 to 5% by weight.

In the present invention, these UV absorbers may be used independently or may be used as a mixture of two or more different kinds.

(Antioxidant)

As such an antioxidant, a hindered-phenol type compound is used preferably. For example, 2,6-di-t-butyl-p-cresol, a penta ERIS retail-tetrakis [3-(3,5-di-t-butyl-4 hydroxyphenyl) propionate], triethylene glycol-bis [3-(3-t-butyl-5-methyl-4 hydroxyphenyl) propionate], 1,6-dihydroxyhexane-bis [3-(3,5-di-t-butyl-4 hydroxyphenyl) propionate], 2 and 4-bis-(n-octylthio)-6-(4-hydroxy-3,5-di-t-butyl anilino)-l, 3, and 5-triazine, 2 and 2-chio-diethylenebis [3-(3,5-di-t-butyl-4 hydroxyphenyl) propionate], Octadecyl-3-(3,5-di-t-butyl-4 hydroxyphenyl) propionate, N and N′-hexamethylene bis (3,5 -di-t-butyl-4-hydroxy-hydrocinnamide), 1, 3, and 5-trimethyl-2,4, 6-tris (3,5-di-t-butyl-4-hydroxy benzyl) benzene, tris-(3,5-di-t-butyl-4-hydroxy benzyl)-isocyanurate, etc. may be listed. In particular, 2,6-di-t-butyl-p-cresol, a penta erisretil-tetrakis [3-(3,5-di-t-butyl-4 hydroxyphenyl) propionate], and a triethylene glycol-bis [3-(3-t-butyl-5-methyl-4 hydroxyphenyl) propionate] are desirable. Moreover, for example, phosphorus type processing stabilizers, such as metal deactivator of hydrazine types, such as an N and N′-bis [3-(3,5-di-t-butyl-4 hydroxyphenyl) propionyl] hydrazine, and tris (2,4-di-t-butylphenyl) phosphight may be used together. As an added amount of these compound, an added amount of 1 ppm to 1.0% at a mass rate to a cellulose derivative is desirable, and 10-1000 ppm are still more desirable.

(Fine Particles)

In the optical film in the present invention, in order to give sliding property, fine particles such as a matting agent can be added. As the fine particles, fine particles of an inorganic compound or fine particles of an organic compound may be listed up, and as their shape, a globular shape, a plate shape, a bar shape, a needle shape, a layer shape, an unfixed shape, etc. are used. As fine particles of an inorganic compound, a metal oxide such as a silicon dioxide, titanium dioxide, aluminium oxide, zirconium oxide, calcium carbonate, calcium carbonate, talc, clay, a baked caolin, a baked calcium silicate, hydration silicic acid calcium, aluminium silicate, magnesium silicate, and calcium phosphate, a hydroxide, a silicate, a phosphate, a carbonate can be mentioned.

As an example of fine particles of an organic compound, fine particles, such as a silicone resin, a fluororesin, and an acryl resin, may be listed up, a silicone resin is desirable, and one having a three dimensional net structure especially is desirable. For example, Tospal 103, 105, 108, 120, 145, 3120, and 240 (manufactured by Toshiba Silicone, Inc.) can be listed up.

Among these, since a silicon dioxide can make the haze of a film small, it is desirable. Fine particles like a silicon dioxide is subjected to a surface treatment with an organic substance in many cases. It is desirable that those fine particles can make the haze of a film small. As a desirable organic substance in the surface treatment, halo silane, alkoxy silane, silazane, siloxane, etc. can be mentioned.

When the average particle diameter of fine particles is larger, the sliding property effect becomes larger, and on the contrary, When the average particle diameter of fine particles is smaller, the transparency is more excellent. Further, the range of the average particle diameter of fine particles is 0.005-1.0 micrometers. Fine particles may be primary particles of these fine particles, or may be second particles made by aggregation. As for the content of fine particles, it is desirable to make it contained in the rage of 0.01 to 20 g per 1 m² of a resin.

As fine particles of a desirable silicon dioxide, fine particles marketed by product names of aerosil 200, 200V, 300, R972, R972V, R974, R202, R812, R805, OX50, and TT600 (manufactured by Japanese Aerosil Co.) can be mentioned, for example. Aerosil 200V, R972, R972V, R974, R202, and R812 can be used preferably. These particles can be used two or more kinds in combination. When two or more kinds are used in combination, these can be used at arbitrary mixing ration. In this case, different particles in average particle diameter and material, for example, Aerosil 200V and R972 can be used within a range of 0.1:99.9 to 99.9:0.1 in mass ratio.

Existence of the fine particles in the film used as the above-mentioned matting agent can be used as another purpose for the improvement in strength of a film.

(Surfactant)

It is desirable to contain a surfactant in a dope solution or a fine particle dispersion liquid used by the present invention, and the surfactant is not limited in particular to a phosphoric acid type, a sulfonic acid type, a carboxylic acid type, a nonion type, a cation type, etc. These are described in a Japanese Patent O.P.I. Publication No. 61-243837, for example. As for the added amount of a surfactant, 0.002 to 2 % by weight to a cellulose acylrate is desirable, and 0.01 to 1 % by weight is more desirable. If the added amount is less than 0.001 % weight, the addition effect may not fully be demonstrated, but the added amount exceed 2 % by weight, it may deposit or a non-dissolved component may be produced.

As a nonion type surfactant, there is a surfactant having polyoxyethylene, polyoxypropylene, polyoxybutylene, polyglycidyl and sorbitan as a nonion type hydrophilicity group, and more concretely, polyoxyethylene alkyl ether, polyoxyethylene alkyl phenyl ether, polyoxyethylene polyoxypropylene glycol, polyhydric alcohol fatty acid partial ester, polyoxyethylene polyvalent alcohol fatty acid partial ester, polyoxyethylene fatty acid ester, poly glycerine fatty acid ester, fatty acid diethanol amide, and triethanolamine fatty acid partial ester can be mentioned.

As an anion type surfactant, there are carboxylate salt, sulfate salt, and sulfonate salt, phosphate salt, and as a typical one, there is a fatty acid salt and alkyl bezel sulfonate salt, an alkyl naphthalene sulfonic acid salt, an alkyl-sulfonic-acid salt, α-olefin sulfonic acid salt, dialkyl sulfo succinate, α-sulfonation fatty acid salt, N-methyl-N oleyl taurine, petroleum sulfonate salt, alkyl sulfate salt, sulfated oil fat, polyoxyethylene alkyl ether sulfate salt, polyoxyethylene alkyl phenyl ether sulfate salt, polyoxyethylene styrene-ized phenyl ether sulfate, alkyl phosphate, polyoxyethylene alkyl ether phosphate salt, a naphthalene sulfonic acid salt formaldehyde condensate, etc..

As a cation type surfactant, an amine salt, a quarternary ammonium salt, a pridium salt, etc. may be listed, and the 1st to 3rd fatty amine salt, and a quarternary ammonium salt (tetra-alkyl ammonium salt, tri alkyl benzyl ammonium salt, an alkylpridium salt, an alkyl imidazolyl salt, etc.) can be listed. As an amphoteric type surfactant, calboxy betaine, sulfo betaine, etc., and they are N-tri alkyl-N- calboxy methyl ammonium betaine, N-tri alkyl-N-sulfo alkylene ammonium betaine, etc. can be listed.

A fluorine type surfactant is a surfactant which makes a-fluorocarbon chain as a hydrophobic group.

(Peeling Accelerator)

Furthermore, a peeling accelerator for making load at the time of peeling small may be added in a dope solution. As a peeling accelerator, a surfactant is effective and there is a phosphoric acid type, a sulfonic acid type, a carboxylic acid type, a nonion type, a cation type, etc., however, it is not limited in particular to these. These peeling accelerators are listed in, for example, a Japanese Patent O.P.I. Publication No. 61-243837 etc. Polyethoxylized phosphate ester is disclosed a Japanese Patent O.P.I. Publication No.57-500833 as a peeling accelerator. Japanese Patent O.P.I. Publication No. 61-69845 discloses that peeling can be conducted quickly by adding mono or di-phosphoric acid alkyl ester, whose non-esterified hydroxy group is in the form of free acid, into a cellulose ester. Moreover, Japanese Patent O.P.I. Publication No. 1-299847 discloses that peeling load can be reduced by adding a phosphate compound including a non-esterified hydroxyl group and a propylene oxide chain and inorganic substance particles.

(Other Additives)

In addition, a heat stabilizer, such as inorganic fine particles, such as kaolin, talc, a diatom earth, quartz, calcium carbonate, barium sulfate, a titanium oxide, and alumina, and a salt of alkaline earth metals, such as calcium, and magnesium may be added. Furthermore, an antistatic additive, a fire retardant, lubricant, an oily agent, etc. may be added.

Next, the embodiments of the present invention will be explained with reference to the accompanying drawings.

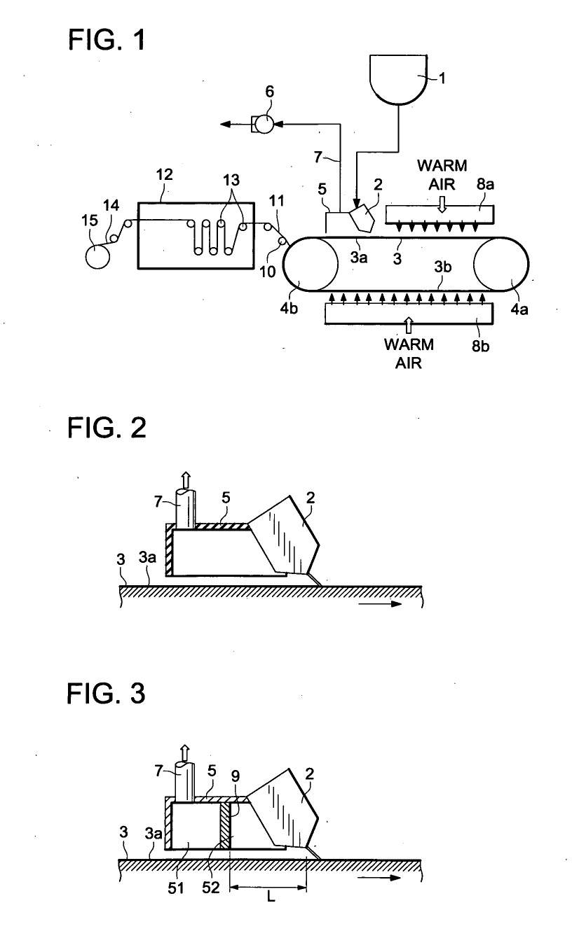

FIG. 1 is a flow sheet schematically showing the dope regulating step, casting step, and drying step of the solvent casting film forming method for optical films.

Dissolving Step

By referring to FIG. 1, firstly, as an example of a thermoplastic resin film material (macromolecular material), cellulose ester will be explained. To dissolve cellulose ester, means such as the stirring dissolving method, heating dissolving method, and ultrasonic dissolving method in a still 1 are used generally, and a method for heating cellulose ester, under pressure, at the boiling point of the solvent or higher at the normal pressure and at a temperature within the range where the solvent does not boil and dissolving it by stirring is more preferable to prevent an occurrence of massive undissolved substances called gel or agglomeration. Further, the cooling dissolving method described in Japanese Patent Application 9-95538 or the method for dissolving under high pressure described in Japanese Patent Application 11-21379 may be used.

A method for mixing and wetting or swelling cellulose ester as a poor solvent and then mixing and dissolving it as a good solvent is used preferably. At this time, an apparatus for mixing and wetting or swelling cellulose ester as a poor solvent and an apparatus for mixing and dissolving it as a good solvent may be installed separately.

According to the present invention, the kind of the still 1 (pressurizing container) used to dissolve cellulose ester is no particular object and any one which can withstand a predetermined pressure and can be heated and stirred under pressure is acceptable. On the still (pressurizing container) 1, instruments such as a manometer and a thermometer are arranged properly. For pressurization, a method for pressing in inactive gas such as nitrogen gas or a method for heating and increasing the vapor pressure of the solvent may be used. The still 1 is preferably heated from the outside and for example, the jacket type is preferable because the temperature thereof can be controlled easily.

The heating temperature by adding a solvent is the boiling point of the solvent used or higher and when two or more mixing solvents are used, a temperature which is equal to the boiling point of the solvent having a low boiling point or higher and is within the range where the solvent does not boil is preferable. When the heating temperature is excessively high, the necessary pressure is increased and the productivity gets worse. The heating temperature is preferably within the range from 20 to 120° C., more preferably within the range from 30 to 100° C., and most preferably within the range from 40 to 80° C. Further, the pressure is regulated so that the solvent does not boil at a preset temperature.

In addition to cellulose ester and the solvent, a necessary additive such as a plasticizer or an ultraviolet absorber may be mixed with the solvent beforehand and dissolved or dispersed, and then introduced into the solvent before cellulose ester is dissolved or introduced in the dope after cellulose ester is dissolved.

After cellulose ester is dissolved, it is taken out from the container by cooling or is pulled out from the container by a pump and is cooled by a heat exchanger, thus the cellulose ester dope obtained is used to form a film and at this time, it may be cooled to the normal temperature.

In the method of the present invention, the cellulose ester dope is filtered, thus foreign substances, particularly in the liquid crystal display, foreign substances recognized as an image by mistake must be removed. It may be said that the quality as optical films is decided by this filtration.

Casting Step

The casting step is a step of sending the dope regulated by the still 1 to a casting die 2 by a conduit and casting the dope from the casting die 2 to the casting position on a support body 3 composed of an endless support body for transferring endlessly, that is, for example, an endless belt made of rotation driving stainless steel (or a drum made of rotation driving stainless steel). The surface of the support body 3 is a mirror surface.

As shown in FIG. 2, on the surface (casting surface) of an upper moving section 3a of the support body 3 composed of the endless belt wound round a pair of front-side and rear-side drums 4a and 4b, the dope casting die 2 for casting the dope which is a material solvent of films and a pressure reducing chamber 5 as a pressure reducing means from the upstream side of a casting film, when forming the casting film (web) on the support body by the dope casting die 2, so as to form the web by adhering onto the support body 3 are installed. Here, the front-side drum 4a round which the endless belt support body 3 is wound is a hot water drum and the rear-side drum 4b is a cooling water drum.

The casting die 2 (for example, pressurizing dies), since the slit shape of the head can be regulated, can preferably make easily the film thickness uniform. As a casting die 2, there are a coat hanger die and a T die available and they are all used preferably. To increase the, film forming speed, two casting dies 2 are installed on the support body 3 and the dope amount may be divided into two layers. And, the dope regulated so as to set the dope viscosity to 1 to 200 poise is cast on the support body 3 from the casting die 2 almost to a uniform film thickness.

Further, the pressure reducing chamber 5 is in a box shape having an opened bottom and is composed of a back plate, left and right side plates, and an upper plate, and the front thereof uses, for example, the wall surface of the casting die 2. However, needless to say, it is not limited to the aforementioned. To the upper plate of the pressure reducing chamber 5, a suction pipe 7 is connected, and through the suction pipe 7, due to the difference between the upper plate and a pressure reducing blower 6, the dope casting section is set into a predetermined negative pressure state.

According to the present invention, the dope (solvent) in which cellulose ester resin is dissolved in a solvent is cast on the moving endless belt (support body) 3 made of rotation driving metal from the casting die 2, and by reducing the pressure of the casting section of the casting die 2 by the pressure reducing chamber (pressure reducing means) 5 installed behind the casting die 2 in the moving direction of the support body, films are formed.

The characteristic of the present invention is that a dope (solvent) with a thermoplastic resin film material (macromolecular material) dissolved in a solvent is cast onto an endless belt running at a moving speed of 50 to 225 m/min (hereinafter, referred to as support body) from a casting die to form a film and the pressure of the casting section of the casting die is reduced by a pressure reducing means installed behind the casting die in the support body moving direction, the support body temperature at time of casting is set within the temperature range expressed by Formula (1) indicated below.
−0.01CS+0.005ΔP+5≦T≦−0.125CS+0.04ΔP+17 (1)

In the formula, T indicates a temperature (°C.) of the support body 3 at the casting section, CS indicates a moving speed (m/min) of the support body 3, and indicates a reduced pressure (Pa) by the pressure reducing means.

Further, it is desirable to set the temperature (°C.) of the support body within a temperature range represented by Formula (2):
−0.01CS+0.005ΔP+9≦T≦−0.125CS+0.04ΔP+12 (2)

Further, it is desirable to satisfy Formula (3):
10≦−0.01CS+0.005ΔP (3)

Further, it is desirable to set the temperature (°C.) of the support body within a temperature range represented by Formula (4):
15≦T≦−0.125CS+0.04ΔP+17 (4)

Further, it is desirable to set the reduced pressure ΔP (Pa) within a range represented by Formula (5):
3CS≦ΔP≦4CS+600 (5)

Incidentally, when the temperature of the support at the casting section is low, there may be a fear that moisture in the atmosphere forms dew condensation on the support right before the casting section, small cloudy patters take place on an obtained film. Therefore, it is desirable to set the temperature of the support higher than 15° C. Further, from the view of production efficiency, the film forming speed is desirably 50 to 225 m/min, more desirably 100 to 200 m/min.

Further, according to the present invention, the dope temperature at time of casting is set 5° C. or more lower than the boiling point of the solvent used and the atmospheric temperature of the casting section is set between 15 and 30 °C.

According to the present invention, in the manufacture of optical films by the solvent casting film forming method, the temperature of the support body 3 immediately before casting of the dope is set within a specific range decided by the moving speed of the support body 3 and the pressure reduction degree of the dope casting section, thus bubbles can be prevented from rolling in free of excessive pressure reduction for making the dope ribbon formed between the liquid outlet of the casting die 2 and the support body 3 unstable. Therefore, for example, even at time of film forming at high speed, a stable casting dope ribbon can be formed at time of dope casting, and optical films of good quality free of irregularities overall the film width and good in flatness can be obtained, and when the optical films are applied to an image display, a visible display having a high contrast ratio in a wide range can be realized. Moreover, optical films, even at a high temperature and high humidity, can ensure a stable phase difference value.

And, according to the present invention, in addition to the aforementioned effect, the dope temperature at time of casting is lowered, and the atmospheric temperature at time of casting can be kept appropriately, thus an occurrence of transverse irregularities of the formed films can be prevented.

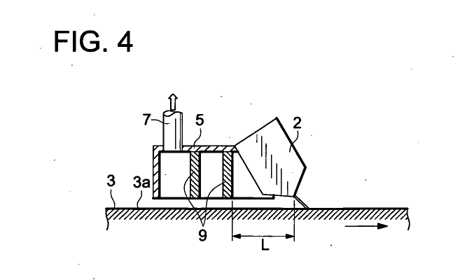

Further, according to the present invention, as shown in FIGS. 3 and 4, at least one partition plate 9 is preferably installed in the hanging state from the upper plate in the pressure reducing room of the pressure reducing chamber (pressure reducing means) 5.

The preferable manufacturing apparatus of optical films according to the present invention as an improved example of an apparatus shown in FIG. 2, has the casting die 2 for casting the dope (solvent) with a thermoplastic resin film material dissolved in a solvent onto the endless belt (support body) 3 made of a rotation driving metal and the pressure reducing chamber 5 as a pressure reducing means of the dope casting section installed behind the casting die 2 in the support body moving direction, and at least one partition plate 9 is installed almost in the hanging state in the pressure reducing room in an almost box shape opened below the pressure reducing chamber (pressure reducing means) 5 and the distance (L) between the partition plate 9 closest to the casting die 2 and the liquid outlet of the casting die 2 is set to 50 to 150 mm as shown in FIGS. 3 and 4.

As shown in FIG. 3, the pressure reducing room is divided into a first pressure reducing room 51 and a second pressure reducing room 52. For the first pressure reducing room 51, there is provided an air suction port 7 connected to a pressure reducing blower 6. When the width of a film to be produced is wider such as 1.8 to 3 m, plural suction ports 7 are provided along the width direction. In this case, air flows may be caused due to air suction among the plural suction ports 7 and streak-shaped unevenness may be caused by the air flows. To counter this, in the present invention, there is provided a partition plate 9 in the pressure reducing room in order to prevent air flows due to air suction from taking place in the second pressure reducing room, thereby preventing streak-shaped unevenness from taking place.

Further, with the movement of the support, air in the vicinity of the surface of the support moves toward the dope casting section and collides a dope ribbon formed between the discharging port of the casting die and the support. As a result, there is a fear that the dope ribbon vibrates with the collision and the dope ribbon takes air in it. However, the partition plate 9 of the present invention can prevent air in the vicinity of the surface of the support from moving toward the dope casting section. As a result, the partition plate 9 has a effect to prevent the dope ribbon from taking air in it. In this case, it may be better that a gap between the partition plate 9 and the support is as small as possible. However, there is a fear that the partition plate 9 may come in contact with the support and then damage the support and the damaged support transfers the damage to a film cast onto the support and degrades the quality of the film. Therefore, it may be desirable that the gap between the partition plate 9 and the support is 2 mm to 20 mm, more preferably 5 mm to 10 mm.

Here, in FIG. 3, one partition plate 9 is installed in the pressure reducing room of the pressure reducing chamber (pressure reducing means) 5 and in FIG. 4, two partition plates 9 are installed at a predetermined interval in the pressure reducing room of the pressure reducing chamber (pressure reducing means) 5, and in either case, according to the present invention, the distance (L) between the partition plate 9 closest to the casting die 2 and the liquid outlet of the casting die 2 is set to 50 to 150 mm.

Further, the reduced pressure ΔP (Pa) is an absolute value of a reduced pressure applied on a back surface of a ribbon, in the moving direction, formed on the support. In the embodiment shown in FIG. 3, the reduced pressure ΔP (Pa) is an absolute value of a reduced pressure in the second pressure reducing chamber 52.

As mentioned above, the partition plate 9 is installed in the pressure reducing room of the pressure reducing chamber (pressure reducing means) 5, and the distance between the partition plate 9 and the casting dope ribbon is kept appropriately, thus even at time of film forming at high speed, a stable casting dope ribbon can be formed at time of dope casting, and bubbles can be prevented from rolling in, and optical films of good quality free of irregularities overall the film width and good in flatness can be obtained.

Solvent Evaporation Step

The solvent evaporation step is a step of heating a dope film (web) 11 formed on the endless belt support body 3 by the cast dope on the support body 3 and evaporating the solvent until the web 11 can be separated from the support body 3.

To evaporate the solvent, there are a method for blowing air from the side of the web 11 and/or a method for transferring heat by a liquid from the rear of the support body 3, and a method for transferring heat by radiant heat from the front and rear.

According to this embodiment, a first drier 8a on the belt surface side is installed opposite to the upper moving section 3a of the endless belt support body 3 and a second drier 8b on the belt surface side is installed opposite to the lower moving section 3b of the endless belt support body 3.

And, the first drier 8a on the belt surface side of the upper moving section 3a of the support body 3, for example, begins to blow drying air onto the web surface starting from the state that the surface residual solvent amount of the web is reduced to 300% or less and dries the web. In this case, it is preferable by drying air blowing header to blow drying air at a temperature between 20 and 60° C. and at an inner static pressure of the header between 500 and 1500 Pa to the web surface.

Next, after passing the surface-side first drier 8a, it is preferable for the second drier 8b on the belt surface side of the lower moving section 3b of the support body 3 to blow drying air at a temperature between 50 and 80° C. and at an inner static pressure of the header between 100 and 1200 Pa onto the web surface in the state-that the surface residual solvent amount is reduced to less than 100% by the drying air blowing header.

Separation Step

As shown in FIG. 1, the separation step is a step of separating the web 11 with the solvent evaporated on the support body 3 by a separation roll 10. The separated web 11 is sent to the next step. When the residual solvent amount (the formula described later) of the web 11 at time of separation is excessively large, the web is hardly separated and inversely, when it is dried sufficiently on the support body 3 and then is separated, a part of the web 11 is separated halfway. According to the present invention, when separating a thin web from the support body 3, to execute it free of deterioration of the flatness and cramping, the minimum separation tension for separating the web is preferably less than 170 N/m and more preferably less than 140 N/m.

As a method for increasing the film forming speed (the web is separated while the residual solvent amount is as large as possible, so that the film forming speed can be increased), there is a gel casting method available. There are a method for adding a poor solvent to cellulose ester during doping and gelling it after dope casting and a method for lowering the temperature of the support body 3 for gelling available. The web is gelled on the support body 3 to increase the film strength at time of separation, so that the separation is speeded up and the film forming speed can be increased. Depending on the drying condition of the web 11 on the support body 3 and the length of the support body 3, the web can be separated within the range from 5 to 150 wt %. However, when separating the web when the residual solvent amount is larger, if the web 11 is too soft, the flatness may be damaged at time of separation, and cramping and longitudinal streaks due to the separation tension occur easily, thus in view of the economical speed and quality, the residual solvent amount at time of separation is decided. Therefore, according to the present invention, the temperature at the separation position on the support body 3 is set between 10 and 40° C., preferably between 15 and 30° C. and the residual solvent amount of the web 11 at the separation position is preferably set between 10 and 120 wt %.

To maintain good flatness of cellulose ester films at time of manufacture, the residual solvent amount when separated from the support body 3 is preferably set between 10 and 150 wt %, more preferably between 70 and 150 wt %, and particularly preferably between 100 and 130 wt %. The ratio of a good solvent contained in the residual solvent is preferably between 50 and 90%, more preferably 60 and 90%, and particularly preferably 70 and 80%.

According to the present invention, the residual solvent amount can be expressed by the formula indicated below.
Residual solvent amount (wt %)={(M−N)/N}×100

where M indicates the weight of the web at an optional time, which is a weight measured by the following gas chromatography and N indicates the weight when M is dried at 110° C. for 3 hours. For measurement, for example, Gas Chromatography 5890 type SERISII and Head Space Sampler HP7694 by Hewlette-Packard can be used.

Drying Step

After separation, generally as shown in FIG. 1, the web 11 is dried using a roll drier 12 for transferring the web 11 by passing through a plurality of transfer rolls 13 and a tentering device (not drawn) for transferring the web 11 by grasping both ends thereof. In FIG. 1, the roll drier 12 having the transfer rolls 13 is arranged behind the separation roll 10. However, the present invention is not limited only to this arrangement.

The drying means generally blows hot air on both sides of the web, though there is a means for heating by irradiating microwaves instead of air. Extremely sudden drying is apt to damage the flatness of the finished films. As a whole, the normal drying temperature is within the range from 40 to 250° C. The drying temperature, drying air amount, and drying time vary with the solvent used and the drying conditions may be selected properly according to the kind and combination of solvents to be used.

At the stretching step by the tentering device-not drawn, the stretching magnification when manufacturing cellulose ester films is 1.01 to 3 times of that in the film forming direction or width direction and preferably 1.5 to 3 times. When stretching biaxially, the stretching magnification on the high-magnification stretching side is 1.01 to 3 times and preferably 1.5 to 3 times, and the stretching magnification in the other direction is 0.8 to 1.5 times and preferably 0.9 to 1.2 times.

Width holding and transverse stretching at the film forming step are preferably executed by the tentering device and either of the pin tenter and clip tenter may be used.

After the stretching step by the tentering device, the post-drying step is preferably installed. The film transfer tension at the post-drying step is affected by the physical properties of dope, the residual solvent amount at time of separation and at the film transfer step, and the temperature at the post-drying step, though it is preferably 120 to 200 N/m, more preferably 140 to 200 N/m, and most preferably 140 to 160 N/m.

To prevent films from extension in the transfer direction at the post-drying step, a tension cut roll is installed preferably. After end of drying, it is preferable to obtain a good winding posture to install a slitter and cut off the end before winding.

Winding Step

As shown in FIG. 1, the winding step is a step of winding the web finishing drying as a film 14 by a winder 15 and obtaining an original roll of optical films. The residual solvent amount of the film 14 finishing drying is 0.5 wt % or less, preferably 0.1 wt % or less, thus good films having stable dimensions can be obtained.

The film winding method may use a winder generally used, and there are methods for controlling the tension such as a constant torque method, a constant tension method, a taper tension method, and a program tension control method of fixed internal stress, and those methods may be used appropriately.

The thickness of cellulose ester films varies with the use object and from the viewpoint of a thin liquid crystal display, the thickness of finished films is preferably within the range from 10 to 150 μm, more preferably within the range from 30 to 100 μm, and particularly preferably within the range from 40 to 80 μm. When films are excessively thin, for example, the strength necessary as a polarizing plate protective film may not be obtained. When films are excessively thick, the superiority of thinness to conventional cellulose ester films is lost. For regulation of the film thickness, to obtain a desired thickness, it is desirable to control the dope concentration, the liquid sending amount of the pump, the slit gap of the head of the casting die 2, the pressing pressure of the casting die 2, and the speed of the support body 3. Further, as a means for making the film thickness uniform, it is desirable to feed back and regulate programmed feedback information to the units aforementioned using a film detection means.

At the steps up to drying immediately after casting by the solvent casting film forming method, the atmosphere in the drier may be air, though an inactive gas atmosphere such as nitrogen gas or carbon dioxide gas may be used. However, needless to say, the danger of the explosion limit of the evaporation solvent in the drying atmosphere must be always taken into account.

Cellulose ester films of the present invention, due to good moisture vapor permeability and dimensional stability, is preferably used as a liquid crystal display member, in detail, a polarizing plate protective film. Particularly, in the polarizing plate protective film strictly requiring the moisture vapor permeability and dimensional stability, the cellulose ester film of the present invention is used preferably.

Generally, when using a cellulose ester film as a polarizing plate protective film, to obtain good adhesion with the polarizer, it is alkaline-saponified. To stick the film after alkaline saponification to the polarizer using a polyvinyl alcohol water solution as an adhesive, when the contact angle of the cellulose ester film after alkaline saponification with water is high, the film cannot be stuck by polyvinyl alcohol, thereby comes into a problem as a polarizing plate protective film.

When using the cellulose ester film manufactured by the method of the present invention as an LCD member, high flatness is required to reduce light leakage of the film. However, the flatness (Ra) of the center line of an optical film is specified in JIS B 0601 and as a measuring method, for example, a stylus method and an optical method may be cited.

According to the present invention, the flatness of center line (Ra) of a cellulose ester film is preferably 20 nm or less, more preferably 10 nm or less, and particularly preferably 4 nm or less.

Next, the polarizing plate using a cellulose ester film manufactured by the method of the present invention as a polarizing plate protective film and the liquid crystal display using the concerned polarizing plate will be explained.

The polarizing plate can be prepared by a general method. The cellulose ester film alkaline-saponified of the present invention is preferably stuck to at least one surface of a polarizer prepared by immersing and stretching a polyvinyl alcohol film in an iodine solution using a perfect saponifiable polyvinyl alcohol water solution. Also for the other surface, the cellulose ester film of the present invention may be used or another polarizing plate protective film may be used. For the cellulose ester film of the present invention, the polarizing plate protective film used for the other surface may use a cellulose ester film on sale. For example, as a cellulose ester film on sale, KC8UX2M, KC4UX, KC5UX, KC4UY, KC8UY, KC12UR, KC8UY-HA, KC8UX-RHA, and KC8UX-RHA-N (these are all manufactured by Konica Minolta Opto Co., Ltd.) are used preferably. Or, films of cyclic olefin resin, acryl resin, polyester, and polycarbonate other than a cellulose ester film may be used as a polarizing plate protective film of the other surface. In this case, the saponification suitability is low, so that it is preferable to stick it to the polarizing plate via an appropriate bonding layer.

In the polarizing plate of the present invention, the cellulose ester film of the present invention is used as a polarizing plate protective film on at least one of the polarizer. At this time, it is preferable to arrange the lagging axis of the cellulose ester film so as to be practically parallel with or orthogonal to the absorption axis of the polarizer.

It is preferable to use this polarizing plate as another polarizing plate arranged across the liquid crystal cell of a horizontal electric field switching mode type and arrange the cellulose ester film of the present invention on the liquid crystal display cell side.

As a polarizer used for the polarizing plate of the present invention, a polyvinyl alcohol polarizing film may be cited and it is dyed with a two-color dye together with a polyvinyl alcohol film dyed with iodine. As a polyvinyl alcohol film, a denatured polyvinyl alcohol film denatured by ethylene is used preferably. As a polarizer, a polyvinyl alcohol water solution is formed to a film, is stretched monoaxially and dyed, or dyed and stretched monoaxially, and then is preferably durable-processed by a boron compound.

The film thickness of the polarizer is 5 to 40 μm, preferably 5 to 30 μm, and particularly preferably 5 to 20 μm. Onto the surface of the concerned polarizer, one side of the cellulose ester film of the present invention is stuck to form a polarizer. It is preferable to stick it using an aqueous adhesive having a main component of perfect saponifiable polyvinyl alcohol. Further, when using a resin film other than a cellulose ester film, it can be stuck to the polarizing plate via an appropriate adhesive layer.

The polarizer is stretched monoaxially (generally in the longitudinal direction), so that when the polarizing plate is put in an environment of high temperature and high humidity, it contracts in the stretching direction (generally in the longitudinal direction) and stretches in the direction perpendicular to stretching (generally in the width direction) . As the polarizing plate protective film becomes thinner, the degree of stretching of the polarizing plate increases and particularly the degree of shrinkage of the polarizer in the stretching direction is high. Generally, the stretching direction of the polarizer is stuck to the casting direction (MD direction) of the polarizing plate protective film, so that when making the polarizing plate protective film thinner, particularly it is important to suppress the degree of stretching in the casting direction. The cellulose ester film of the present invention is excellent in the dimensional stability, so that it is preferably used as such a polarizing plate protective film.

The polarizing plate-can be formed additionally by sticking a protect film onto one surface of the polarizing plate and a separate film onto the opposite surface. The protect film and separate film, at time of shipment of the polarizing plate and product inspection, is used to protect the polarizing plate.

The optical films of the present invention have an excellent surface quality which is superior in the flatness and is free of failures such as bubble detects and a liquid crystal display using an optical film prepared by the present invention has an excellent quality free of irregularities on the screen.

### EXAMPLES

Hereinafter, the present invention will be explained more concretely by referring to the embodiments, though the present invention is not limited to them.

### Embodiment 1 (Examples 1 to 30)

To manufacture a cellulose acetate propionate film of the present invention by the solvent casting film forming method, firstly, a dope is prepared.

Dope Preparation

Cellulose triacetate propionate: 100 parts by weight (degree of substitution of acetyl group 1.95, degree of substitution of propionate 0.7)

Triphenyl phosphate: 10 parts by weight

Ethyl phthalyl ethyl glycolate: 2 parts by weight

Tinuvin 326 (by Ciba Specialty Chemicals, Ltd.): 1 part by weight

AEROSIL 200V (by Nihon Aerosil, Ltd.): 0.1 parts by weight

Methylene chloride: 300 parts by weight

Ethanol: 40 parts by weight

As shown in FIG. 1, the materials aforementioned are sequentially introduced into the closed container (still) 1, and the temperature in the container is increased from 20° C. to 80° C., and then the materials are stirred for 3 hours in the state that the temperature is kept at 80° C., and cellulose triacetate propionate is dissolved completely.

Thereafter, the stirring is stopped and the liquid temperature is lowered to 43° C. The dope of cellulose acetate propionate is sent to a filter, is filtered through a filter paper (by Asaka Filter Paper, Ltd., Asaka Filter Paper No. 244), thus a casting dope is obtained. The obtained dope is stored in a stock tank (not drawn), is deaerated, and then is filtered by the filter (not drawn), thus the dope is prepared.

Next, as shown in FIGS. 1 and 2, the dope of cellulose acetate propionate prepared as mentioned above passes through the casting die 2 kept at 35° C., is cast onto the support body 3 composed of the moving endless belt made of stainless steel, and is formed in a film by reducing the pressure of the casting section of the casting die 2 by the pressure reducing chamber (pressure reducing means) 5 installed behind the casting die 2 in the moving direction of the support body.

According to the present invention, the support body temperature at time of dope casting is set within the temperature range expressed by Formula (1) indicated below.
−0.01CS+0.005ΔP+5≦T≦−0.125CS+0.04ΔP+17 (1)

In the formula, T indicates a temperature (°C.) of the support body 3 at time of casting, CS a moving speed (m/min) of the support body 3, and ΔP a reduced pressure (Pa) by the pressure reducing means.

Here, the temperature of the support body 3 of the dope casting section is measured by an emission thermometer (AR-1501 by Adachi Keiki, Ltd.) installed immediately before the casting section. And, the temperature of the support body 3 at time of dope casting is changed by properly regulating the temperature the rear-side cooling water drum 4b and the temperature of the second drier 8b.

Further, at this time, the temperatures of the first drier 8a and the front-side hot water drum 4a are regulated properly, thus the residual solvent amount of the web at time of separation is set to almost 80 wt %.

Further, according to the inventions of the claims of the present invention, the dope temperature at time of casting is set 5° C. or more lower than the boiling point of the solvent used. However, in Embodiment 1, the dope temperature at time of casting is set at 36° C. which is lower by 4° C. than the boiling point 40° C. of methylene chloride which is a solvent used. Further, the atmospheric temperature of the casting section is set at 31° C.

And, the dope film (web) is dried on the support body 3 until the residual solvent amount in the web is finally reduced to 80 wt % by the first drier 8a on the belt surface side opposite to the upper moving section 3a of the endless belt support body 3 and the second drier 8b on the belt surface side opposite to the lower moving section 3b of the support body and then the web 11 is separated from the support body 3 by the separation roll 10.

The web 11 separated, after the solvent is evaporated until the residual solvent amount is reduced to 20% at 40° C., is stretched 1.3 times at 130° C. in the TD direction (the direction orthogonal to the transfer direction of the film) by the tentering device (not drawn) . Thereafter, the web 11 passes the drier 12 at 120° C. by being transferred by many transfer rolls 13, finishes drying, is slit at both ends of the film 14 by 30 mm each, and is wound by the winder 15, thus a cellulose acetate propionate film with a thickness of 80 μm is obtained.

### Examples 1 to 10

A casting speed was set at 75 m/min, a film having a width of 2000 mm and a thickness of 80 μm was formed under the condition indicated in Table 1. The temperature of the support at the casting section was changed by adjusting the temperature of a cooling water drum properly. Incidentally, the remaining solvent amount at the time of pealing the film from the support was adjusted to become 95% by adjusting the temperature of air discharged from a warm air header.

In Table 1, the speed CS (m/min) of the support 3, the reduced pressure ΔP (Pa) of the pressure reducing room 5, the temperature T2 (°C.) of a rear side cooling water drum 4b are described and also the temperature T1 (° C.) of the support at the casting section adjusted to satisfy the formula (1) is indicated.

### Comparison Examples 1 and 2

For comparison, as shown in Table 1 indicated below, in Comparison Example 1, the support body temperature T of the dope casting section is set higher than that of Example 4 of the present invention. In Comparison Example 2, the support body temperature T at the dope casting section is set lower than that of Example 6 of the present invention.

The other respects of Comparison Examples 1 to 2 are similar to those of Examples 4 and 6 and a cellulose acetate propionate film is prepared.

For the cellulose acetate propionate films prepared by Examples 1 to 10 and Comparison Examples 1 and 2 of the present invention, the bubble rolling-in of films and the stability of the dope ribbon are evaluated according to the method indicated below and the results obtained are summarized in Table 1.

Evaluation 1: In the evaluation of bubble rolling-in of films, the number of bubbles (diameter is 0.5 mm or more) in 100 m of the cellulose acetate propionate film obtained is measured and the results are classified into the ranks indicated below.

Rank: The number of bubbles

A: 0

B: 1 to 5 pieces

C: More than 5 pieces

Evaluation 2: In the evaluation of the stability of the dope ribbon at time of dope casting, the cellulose acetate propionate film obtained is cut into pieces of 2-m length, and the cut pieces are put on a plane, and the height of surface waviness at both ends of each piece is measured, and the results are classified into the ranks indicated below.

Rank: Height of surface waviness

A: Less than 1 mm

B: 1 to 3 mm

C: More than 3 mm

Evaluation 3: The obtained film is cut into pieces of 1-m length, streak, unevenness and flatness was evaluated visually and the results are classified into the ranks indicated below.

Rank: Appearance evaluation

A: streak, unevenness was not-observed, flatness was no problem

B: streak, unevenness was not observed slightly, however there was no problem in practical use

C: unevenness was not observed

TABLE 1

| | | | | | Evalua- | Evalua- | Evalua- |
|---|---|---|---|---|---|---|---|
| | | | | | tion | tion | tion |
| | CS | ΔP | T2 | T | 1 | 2 | 3 |
| Example 1 | 75 | 250 | 10 | 12.5 | B | A | B |
| Example 2 | 75 | 300 | 14 | 16 | A | A | A |
| Example 3 | 75 | 300 | 4 | 6 | A | A | B |
| Example 4 | 75 | 450 | 22 | 24 | A | A | A |
| Example 5 | 75 | 450 | 18 | 20.5 | A | A | A |
| Example 6 | 75 | 450 | 5 | 7.5 | A | A | B |
| Example 7 | 75 | 1000 | 40 | 42 | A | A | A |
| Example 8 | 75 | 1000 | 9 | 10.5 | A | A | B |
| Example 9 | 75 | 1100 | 42 | 45 | A | B | A |
| Example 10 | 75 | 1100 | 8 | 10.5 | A | B | A |
| Comp. 1 | 75 | 450 | 24 | 26 | C | A | C |
| Comp. 2 | 75 | 450 | 4 | 6 | A | A | C |

### Examples 11 to 20

A casting speed was set at 100 m/min, a film having a width of 2000 mm and-a thickness of 80 μm was formed under the condition indicated in Table 2. The temperature of the support at the casting section was changed by adjusting the temperature of a cooling water drum properly. Incidentally, the remaining solvent amount at the time of pealing the film from the support was adjusted to become 95% by adjusting the temperature of air discharged from a warm air header.

### Comparison Examples 11 and 12

For comparison, as shown in Table 2 indicated below, in Comparison Example 11, the support body temperature T of the dope casting section is set higher than that of Example 14 of the present invention. In Comparison Example 12, the support body temperature T at the dope casting section is set lower than that of Example 16 of the present invention.

The cellulose acetate propionate films prepared by Examples 11 to 20 and Comparison Examples 11 and 12 were evaluated in accordance with Evaluation 1, Evaluation 2, and Evaluation 3, and the results are indicated in Table 2.

TABLE 2

| | | | | | Evalua- | Evalua- | Evalua- |
|---|---|---|---|---|---|---|---|
| | | | | | tion | tion | tion |
| | CS | ΔP | T2 | T | 1 | 2 | 3 |
| Example 1 | 100 | 250 | 10 | 12.5 | B | A | B |
| Example 2 | 100 | 300 | 14 | 16 | A | A | A |
| Example 3 | 100 | 300 | 4 | 6 | A | A | B |
| Example 4 | 100 | 500 | 22 | 24 | A | A | A |
| Example 5 | 100 | 500 | 18 | 20.5 | A | A | A |
| Example 6 | 100 | 500 | 5 | 7.5 | A | A | B |
| Example 7 | 100 | 1000 | 40 | 42 | A | A | A |
| Example 8 | 100 | 1000 | 9 | 10.5 | A | A | B |
| Example 9 | 100 | 1100 | 42 | 45 | A | B | A |
| Example 10 | 100 | 1100 | 8 | 10.5 | A | B | A |
| Comp. 1 | 100 | 500 | 24 | 26 | C | A | C |
| Comp. 2 | 100 | 500 | 4 | 6 | A | A | C |

### Examples 21 to 30

A casting speed was set at 150 m/min, a film having a width of 2000 mm and a thickness of 60 μm was formed under the condition indicated in Table 2. The temperature of the support at the casting section was changed by adjusting the temperature of a cooling water drum properly. Incidentally, the remaining solvent amount at the time of pealing the film from the support was adjusted to become 100% by adjusting the temperature of air discharged from a warm air header.

### Comparison Examples 21 and 22

For comparison, as shown in Table 3 indicated below, in Comparison Example 21, the support body temperature T of the dope casting section is set higher than that of Example 24 of the present invention. In Comparison Example 22, the support body temperature T at the dope casting section is set lower than that of Example 26 of the present invention.

The cellulose acetate propionate films prepared by Examples 21 to 30 and Comparison Examples 21 and 22 were evaluated in accordance with Evaluation 1, Evaluation 2, and Evaluation 3, and the results are indicated in Table 3.

TABLE 3

| | | | | | Evalua- | Evalua- | Evalua- |
|---|---|---|---|---|---|---|---|
| | | | | | tion | tion | tion |
| | CS | ΔP | T2 | T | 1 | 2 | 3 |
| Example 21 | 150 | 400 | 9.5 | 12.5 | B | A | B |
| Example 22 | 150 | 450 | 12.5 | 15.5 | A | A | A |
| Example 23 | 150 | 450 | 10 | 13 | A | A | B |
| Example 24 | 150 | 750 | 22.5 | 26 | A | A | A |
| Example 25 | 150 | 750 | 18 | 21.5 | A | A | A |
| Example 26 | 150 | 750 | 9.5 | 12.5 | A | A | B |
| Example 27 | 150 | 1200 | 37 | 44 | A | A | A |
| Example 28 | 150 | 1200 | 9.5 | 12.5 | A | A | B |
| Example 29 | 150 | 1300 | 43.5 | 46 | A | B | A |
| Example 30 | 150 | 1300 | 9.5 | 12.5 | A | B | A |
| Comp. 21 | 150 | 750 | 33 | 29.5 | C | A | C |
| Comp. 22 | 150 | 750 | 4.5 | 7 | A | A | C |

### Examples 31 to 40

A casting'speed was set at 200 m/min, a film having a width of 2000 mm and a thickness of 40 μm was formed under the condition indicated in Table 4. The temperature of the support at the casting section was changed by adjusting the temperature of a cooling water drum properly. Incidentally, the remaining solvent amount at the time of pealing the film from the support was adjusted to become 110% by adjusting the temperature of air discharged from a warm air header.

### Comparison Examples 31 and 32

For comparison, as shown in Table 4 indicated below, in Comparison Example 31, the support body temperature T of the dope casting section is set higher than that of Example 34 of the present invention. In Comparison Example 32, the support body temperature T at the dope casting section is set lower than that of Example 36 of the present invention.

The cellulose acetate propionate films prepared by Examples 31 to 40 and Comparison Examples 31 and 32 were evaluated in accordance with Evaluation 1, Evaluation 2, and Evaluation 3, and the results are indicated in Table 4.

TABLE 4

| | | | | | Evalua- | Evalua- | Evalua- |
|---|---|---|---|---|---|---|---|
| | | | | | tion | tion | tion |
| | CS | ΔP | T2 | T | 1 | 2 | 3 |
| Example 31 | 200 | 550 | 9.5 | 13.5 | B | A | B |
| Example 32 | 200 | 600 | 11.5 | 15.5 | A | A | A |
| Example 33 | 200 | 600 | 9.5 | 13.5 | A | A | B |
| Example 34 | 200 | 1000 | 28 | 31 | A | A | A |
| Example 35 | 200 | 1000 | 17 | 20 | A | A | A |
| Example 36 | 200 | 1000 | 6 | 9 | A | A | B |
| Example 37 | 200 | 1400 | 42.5 | 45 | A | A | A |
| Example 38 | 200 | 1400 | 7.5 | 11.5 | A | A | B |
| Example 39 | 200 | 1500 | 41.5 | 45 | A | B | A |
| Example 40 | 200 | 1500 | 8 | 12.5 | A | B | A |
| Comp. 31 | 200 | 1000 | 29 | 33 | C | A | C |
| Comp. 32 | 200 | 1000 | 3.5 | 7.5 | A | A | C |

The results of Tables 1, 2, 3 and 4 show that in Examples 1 to 40 of the present invention, the support body temperature T of the dope casting section is within the range of the present invention, so that the bubble rolling-in of the films and dope ribbon stability are not questionable and a cellulose acetate propionate film of good quality can be obtained. Therefore, the cellulose acetate propionate films of E Examples 1 to 40 are sufficiently suited to use as an optical film for the liquid crystal display (LCD).

On the other hand, in Comparison Examples 1, 11, 21 and 31 in which the support body temperature T of the dope casting section is higher than the range of the present invention, the dope ribbon is stable, though rolled-in bubbles are seen in the film. Further, in Comparison Example 2, 12, 22 and 32 in which the temperature T of the dope casting section is lowered more, bubble rolling-in of the film and the dope ribbon stability are not questionable, though on the overall surface of the cellulose acetate propionate film obtained, a foggy pattern occurs.

Incidentally, when the reduced pressure ΔP (Pa) in the pressure reducing room is made lower than the upper limit value of the range represented by the formula (5), the edges of the dope ribbon rarely became disorder and surface waviness at ends of the obtained film was little. Further, when the reduced pressure ΔP (Pa) in the pressure reducing room is made higher than the lower limit value of the range represented by the formula (5), bubble or air rolling-in was little right after casting, the dope ribbon was stable, and transverse unevenness perpendicular to the moving direction was not caused, resulting in that more preferable effects were obtained.
3CS≦ΔP≦4CS+600 (5)

### Embodiment 2 (Improved Example 1)

Similarly to Embodiment 1 aforementioned, a cellulose triacetate propionate film with a thickness of 80 μm is manufactured. As shown in FIG. 3, as Improved example 1 according to the present invention, the pressure reducing chamber (pressure reducing means) 5 having one partition plate 9 formed in the pressure reducing room is used, and the distance (L) between the partition plate 9 closest to the casting die 2 and the liquid outlet of the casting die 2 is set to 100 mm within the range of the present invention from 50 to 150 mm. Further, the other film forming conditions are the same as those of Reference example 1 shown in FIG. 2 in Embodiment 1.

Reference examples 2 and 3

For comparison, Reference examples are executed similarly to Improved example 1. However, as shown in Table 4 indicated below, in Reference Examples 2 and 3, the distance (L) between the partition plate 9 closest to the casting die 2 and the liquid outlet of the casting die 2 is set outside the range (50 to 150 mm) of the present invention.

The other respects of Reference Examples 2 and 3 are similar to those of Improved example 1 aforementioned and a cellulose acetate propionate film is prepared.

For the cellulose acetate propionate films prepared by Improved example 1 and Reference Examples 2 and 3 of the present invention, the number of bubbles (diameter is 0.5 mm or more) in 500 m of the cellulose acetate propionate film obtained is measured and the results are classified into the ranks indicated below and the results are indicated in Table 5.

Rank: The number of bubbles

AA: 0

A: 1 to 3 pieces

B: 3 to 5 pieces

Further, in Table 5, the evaluation results of Reference Example 1 having no partition plate in the pressure reducing room of the pressure reducing chamber (pressure reducing means) 5 are also shown.

TABLE 5

| | | Distance L | |
|---|---|---|---|
| | | between | |
| | | partition plate | |
| | Structure of | and liquid | |
| | pressure | outlet of die | Bubble rolling- |
| | reducing chamber | (mm) | in evaluation |
| Improved | | 100 | AA |
| example 1 | | | |
| Reference | | No partition | B |
| Example 1 | | plate | |
| Reference | | 160 | A |
| Example 2 | | | |
| Reference | | 30 | A |
| Example 3 | | | |

The results of Table 5 show that according to Improved example 1 of the present invention, since the distance L between partition plate and liquid outlet of die is set within a preferable range of the present invention, there is no problem of bubble rolling in of films and a cellulose acetate propionate film of more good quality can be obtained. Therefore, the cellulose acetate propionate film of Improved example 1 is more sufficiently suited to use as an optical film for the liquid crystal display (LCD).

### Embodiment 3 (Improved Example 2)

Similarly to Example 1 in Embodiment 1 aforementioned, a cellulose triacetate propionate film with a thickness of 80 μm is manufactured. However, as Improved example 2 according to the present invention, the dope temperature at time of casting and the atmospheric temperature of the casting section are changed, and the other respects are the same as those of Embodiment 1, and a cellulose acetate propionate film is prepared.

For the cellulose acetate propionate films prepared by Example 1 and Improved example 2 of the present invention, to evaluate transverse film thickness irregularities thereof, the mean roughness of the center line Ra (μm) is measured and the obtained results are shown in Table 6 indicated below.

When using the cellulose acetate propionate film as an LCD member, to reduce the light leakage of the film, high flatness is required. The mean roughness of the center line (Ra) is a value specified in JIS B 0601. In this embodiment, the mean roughness of the center line Ra of the cellulose acetate propionate film is measured using a surface roughness measuring instrument (SV-3100 by Mitsutoyo, Ltd.), and it is measured for 10 cm of the film in the longitudinal direction, and the mean roughness of the center line Ra of the film surface is obtained.

TABLE 6

| | Dope temperature | | Mean roughness |
|---|---|---|---|
| | at time of | Atmospheric | of center line |
| | casting (° C.) | temperature (° C.) | Ra (μm) |
| Example 1 | 36 | 31 | 0.7 |
| Improved | 32 | 25 | 0.2 |
| example 2 | | | |

The results of Table 6 show that according to Improved example 2 of the present invention, the mean roughness of the center line Ra of the cellulose acetate propionate film is a sufficiently low value, thus, the cellulose acetate propionate films of Embodiments 1 and 4 are sufficiently suited to use as an optical film for the liquid crystal display (LCD).

What is claimed is:

1. A method of manufacturing an optical film by a casting apparatus which comprises a support, a casting die provided at a casting section of the support and a pressure reducing device provided at the casting section, the method comprising steps of:
moving the support at a moving speed of 50 to 225 m/min in a moving direction;
casting a dope solution containing a solvent and a thermoplastic resin dissolved in the solvent from a solution outlet of the casting die to a surface of the support so that the dope solution forms a dope ribbon between the solution outlet of the casting die and the surface of the support;
reducing a pressure at a back side of the dope ribbon in the moving direction of the support by the pressure reducing device; and
setting a temperature T of the support at the casting section to satisfy the formula (1):
−0.01CS+0.005ΔP+5≦T≦−0.125CS+0.04ΔP+17 (1)
where CS represents the moving speed (m/min) of the support and ΔP is a reduced pressure (Pa) at the back side of the dope ribbon by the reducing device.

2. The method of claim 1, wherein the setting step sets the temperature T of the support at the casting section to satisfy the formula (2):
−0.01CS+0.005ΔP+9≦T≦−0.125CS+0.04ΔP+12 (2)

3. The method of claim 1, wherein the following formula (3) is satisfied:
10≦−0.01CS+0.005ΔP (3)

4. The method of claim 1, wherein the setting step sets the temperature T of the support at the casting section to satisfy the formula (4):
15≦T≦−0.125CS+0.04ΔP+17 (4)

5. The method of claim 1, wherein the following formula (5) is satisfied:
3CS≦ΔP≦4CS+600 (5)

6. The method of claim 1, wherein the moving speed of the support is 100 to 200 m/min.

7. The method of claim 1, wherein a temperature of the dope solution is 5° C. or more lower than a boiling point of the solution and a atmospheric temperature around the casting section is 15 to 30° C.

8. The method of claim 1, wherein the pressure reducing device comprising a pressure reducing chamber at the back side of the casting die and at least one partition plate provided in the pressure reducing chamber and a distance between the solution outlet of the casting die and a partition plate located closet to the casting die is 50 to 150 mm.

9. The method of claim 8, wherein a gap between the partition plate and support is 2 to 20 mm.
